(19) United States
(12) Patent Application Publication
(10) Pub. No.: US 2012/0309469 A1
(43) Pub. Date: Dec. 6, 2012

(54) TELEPHONE SCREEN PROTECTOR

(75) Inventor: Simone FORNARA, Borgomanero (NO) (IT)

(73) Assignee: Simone FORNARA, Borgomanero (NO) (IT)

(21) Appl. No.: 13/484,314

(22) Filed: May 31, 2012

(30) Foreign Application Priority Data
Jun. 1, 2011 (IT) CO2011U 000005

(51) Int. Cl. H04M 1/02

(52) U.S. Cl. 455/575.1

(57) ABSTRACT

There is proposed a screen protector for cellular telephones Apple Iphone 4 white model, formed by a transparent film made of synthetic material having a first opening (2) comprising a first part (4) such as an opening for the lens of the telephone camera and a second part (5) provided for the interior speakers of the telephone, as well as a second opening (3) provided for the “Home page” key of the telephone, where there is provided a supplementary opening (6), which, after the application of the screen protector (1; 1A; 1B) on the telephone, is arranged above the proximity sensor (7) of the telephone.

### FIELD OF APPLICATION

The present invention refers to a screen-shield or anti-scratch protector for telephones, in particular for Apple Iphone 4 mobile or cellular telephones, white model, according to the preamble of claim 1.

### STATE OF THE ART

As known, Apple recently introduced two Iphone 4 telephones, and more precisely the Iphone 4 black model telephone in June 2010 and the Iphone 4 white model telephone in April 2011 and which represents the “twin” of the previous black one.

The black Iphone 4 telephone has a touch screen which, after purchase thereof, is usually protected by the purchaser by applying on said screen a known screen protector formed by a film made of transparent synthetic material, whose purpose is to prevent the screen from being scratched by nails, keys (when kept in handbags bearing keys), and so on and so forth, such scratches and grazes being capable of jeopardize a clear and distinct reading of the texts on the screen or display over time.

This protector film has, in case of the Apple Iphone 4 black model telephone, two openings which, after the application of the film on the screen, are arranged, one, above the lens of the camera and the interior speakers of the telephone, while the other is above the home page key, where said screen protector or protector film has a surface large enough to substantially entirely cover the surface of the screen or display of the telephone.

The screen protectors known for the Apple Iphone 4 black model telephone allow excellent operation and handling the telephone during the use thereof.

These screen protectors are sold as accessories in packaging bearing three protectors.

The applicant has now observed that the application of a known protector for Iphone 4 black model telephones on the most recent twin Apple Iphone 4 white model telephone frequently creates operating interferences of the telephone during the operation and often sudden interruptions, i.e. problems and inconveniences as indicated below.
Inadvertently pressing the “end” key on the display with the cheek leads to terminating the call.
Inadvertently pressing the display with the cheek may lead to the following drawbacks:
   inadvertent activation of the “hands-free” mode,
   inadvertent activation of the “mute” mode,
   inadvertent activation of the “contacts” mode,
   inadvertent activation of the “another call” mode,
   inadvertent activation of the “keypad” mode,
   inadvertent activation of the “face time” mode.

The drawbacks and malfunctions referred to above are not observable when using the Apple Iphone 4 white telephone without the known screen protector film.

It is however clear that the use of these Apple Iphone 4 white telephones without a screen protector film would lead to the known drawback of a progressive scratching of the touch screen and an ensuing progressive deterioration as regards the texts to be read.

### SUMMARY OF THE INVENTION

Therefore the present invention aims at providing a screen protector for Apple Iphone 4 white telephones capable of overcoming the aforementioned drawbacks and allow/maintain an excellent operation of these Apple Iphone 4 white telephones even after the application of the protector.

The aforementioned object is attained, according to the invention, through a screen protector having the characteristics of claim 1.

Further developments are observable from the dependent claims.

The screen protector according to the invention for the Apple Iphone 4 white telephones allows attaining several advantages.

First and foremost the application of a specific opening for the proximity sensor which—with protector applied on the telephone—allows freely handling of the telephone maintaining an excellent operation of the telephone, can be carried out using known cutting tools and using transparent films made of otherwise known synthetic material, i.e. with extremely low production costs, where said specific opening allows said proximity sensor to read the reflected shadow of the user's face without obstacles.

The small dimension of the proposed supplementary opening practically excludes grazes and scratches that could jeopardise the clear reading of the writings on the screen when handling the telephone, with the telephone in handbags and the like with other objects that can create scratches, such as keys and the like, and so on and so forth.

The screen protector according to the invention can also be used for Apple Iphone 4 black model telephones. Therefore the protectors according to the invention can be sold indistinctively for both Apple Iphone 4 black and white “twin” telephones, hence allowing the sellers not having to stock various accessories, i.e. protectors, for the two twin telephones.

### BRIEF DESCRIPTION OF THE DRAWINGS

Further characteristics, advantages and details of the screen protector according to the invention are can be observed from the following description of two embodiments of screen protectors illustrated by way of example in the attached drawing, wherein:

FIG. 1 is a top view on a known screen protector for the Apple Iphone 4, black model telephone,

FIGS. 2 and 2A are a top view on a screen protector according to the invention created for Apple Iphone 4 white model telephones, respectively without and with approximate dimensions, and

FIGS. 3 and 3A are an analogous top view on a second embodiment of a screen protector according to the invention for Apple Iphone 4 white model telephones, respectively without and with approximate dimensions.

### DESCRIPTIONS OF PREFERRED EMBODIMENTS

In the various figures identical parts have the same reference numbers.

In FIG. 1 the known screen protector for Apple Iphone 4 black model cellular phones, is indicated with 1 and consists in a film made of transparent synthetic material. Therein there are provided two openings 2, 3, where the opening 2 comprises a first part of opening 4 for the lens of the camera and a second part of opening 5 for the interior speakers of the telephone, not illustrated.

The second opening 3 is provided for the “Home page” key, not illustrated, of the telephone.

This screen protector 1, which allows an excellent operation of the Apple Iphone 4 black model telephones, does not allow a reliable operation of the Apple Iphone 4 white model telephones, during the call and during the conversation, hence the users do not use screen protectors.

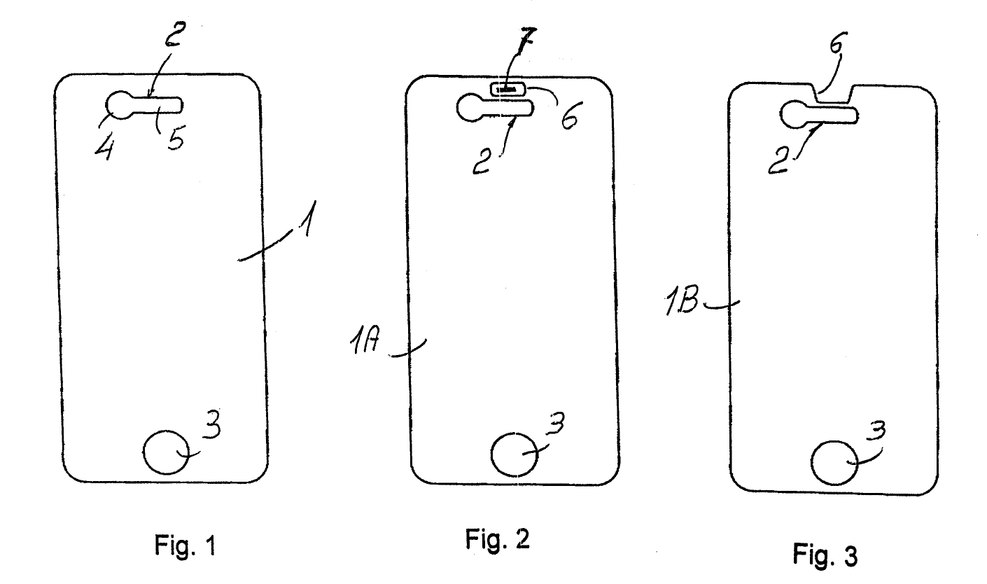

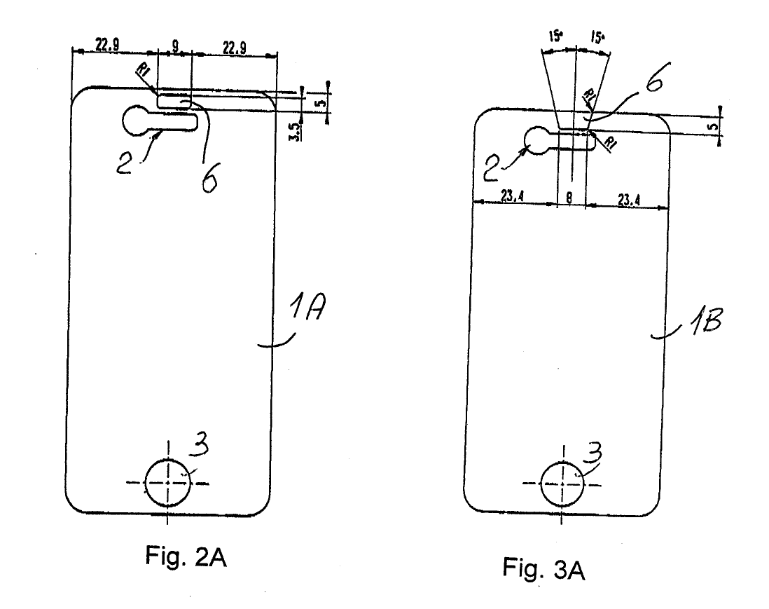

The screen protector 1A of FIG. 2 differs from the screen protector 1 of FIG. 1 due to the fact that, additionally to the openings 2, 3 there is provided a supplementary opening 6 arranged so as to be arranged, after the application of the protector on the telephone, above the proximity sensor, indicated with 7, of the Apple Iphone 4 white model telephones.

In the screen protector 1B of FIG. 3 the opening 6 provided above the proximity sensor 7 is trapezoid-shaped open on the upper side 8 of the protector 1B, whereas in FIG. 4 there are indicated approximate dimensions for such opening 6.

From the different configurations of the two supplementary openings 6 it can be observed that it is essential—regarding said opening 6—to leave a free area around the proximity sensor 7 regardless of the contour of the supplementary opening 6. This shows that the configuration of the supplementary opening 6 can be selected freely, for example being oval-shaped, quadrangular-shaped, and so on and so forth.

A further embodiment, not shown but definitely imaginable, of the supplementary opening 6 consists in joining said opening 6 with the underlying opening 2.

Regarding the invention it is essential to provide a specific supplementary opening 6 which allows the proximity sensor 7 of the telephone to freely “read” the shadows reflected by the face, thus allowing switching off the video and allowing the normal use of the telephone in the call and conversation phase.

From the previously outlined structural and functional description of the screen protector according to the invention it can be observed that the same allows efficiently attaining the indicated object and achieving the mentioned advantages.

Those skilled in the art may introduce modifications and variants of the proposed protector regarding, for example, the type of material the film is made of, the geometric shape of the various openings, the dimensioning thereof and so on and so forth, without departing from the scope of protection of the screen protector films or protections according to the invention, as claimed in the attached claims.

1. Screen protector for cellular telephones, formed by a transparent film made of synthetic material having a first opening (2) comprising a first part (4) such as an opening for the lens of the telephone camera and a second part (5) provided for the interior speakers of the telephone, as well as a second opening (3) provided for the “Home page” key of the telephone, characterised in that it has a supplementary opening (6), which, after the application of the screen protector (1) on the telephone, is arranged above the proximity sensor (7) of the telephone.

2. Screen protector according to claim 1, characterised in that said supplementary opening (6) is rectangular-shaped with rounded corners.

3. Screen protector according to claim 1, characterised in that said supplementary opening (6) is trapezoidal or quadrangular-shaped open towards the external.

4. Screen protector according to claim 1, characterised in that said supplementary opening (6) is integrated with the openings (4 and 5) provided for the lens of the camera and for the interior speakers of the telephone.
